(19) United States
(12) Patent Application Publication
(10) Pub. No.: US 2006/0176769 A1
(43) Pub. Date: Aug. 10, 2006

(54) Drink blender system with a single use disposable drink container

(76) Inventor: Robert Baschnagel III, Bayside, NY (US)

Correspondence Address: Attn: Jeffrey A. Proehl;Leonard & Proehl, Prof. L.L.C., Suite 250, 3500 S. First Ave. Circle, Sioux Falls, SD, 57105-5807, US

(21) Appl. No.: 11/055,205

(22) Filed: Feb. 10, 2005

(51) Int. Cl. A47J 43/046

(52) U.S. Cl. 366/205; 366/314

(57) ABSTRACT

A drink blender system with a single use disposable drink container for permitting a user to dispose of the cup and mixing apparatus after use. The drink blender system with a single use disposable drink container includes a cup defining an interior for receiving constituents of the drink. The cup has an upper end and a lower end. The upper end of the cup having an opening into the interior. A mixing apparatus integrally formed as a single unit with the cup. The mixing apparatus is mounted on the lower end of the cup. The mixing apparatus extends upwardly from the lower end into the interior of the cup. The cup and mixing apparatus are formed of plastic material to permit easy disposal of the cup and the mixing apparatus. A driver assembly for driving the mixing apparatus to mix the constituents of the drink.

### BACKGROUND OF THE INVENTION

1. Field of the Invention

The present invention relates to food blenders and more particularly pertains to a new drink blender system with a single use disposable drink container for providing the user with a relatively low cost system that permits a user to dispose of the cup and mixing apparatus after use.

2. Description of the Prior Art

The use of food blenders is known in the prior art. More specifically, food blenders heretofore devised and utilized are known to consist basically of familiar, expected and obvious structural configurations, notwithstanding the myriad of designs encompassed by the crowded prior art which have been developed for the fulfillment of countless objectives and requirements. In addition to meeting the particular objectives and requirements, the food blenders can be difficult to clean and thus making the food blenders less than desirable to use.

U.S. Pat. No. 6,338,569 to McGill shows a food blending apparatus for blending products in a container where the container is made to be disposed of after the product in the container has been consumed and requires a complex sealing means to ensure that the food within the container does not leak out between the lid and the blender that extends through the lid and therefore increases the cost of the container. U.S. Pat. No. 6,616,323 to McGill shows a food blending apparatus with a blender extending through a closure member of a container with the blender member being capable of being slid up and down in the container to blend the material in the container and allow disposal of the container after use while requiring a complex system for permitting a closure member to be inserted into the upper opening and sealing the upper opening while allowing a blender member to coupled to closure member to allow the material in the container to be blended which adds complexity and additional cost. U.S. Patent Application Publication No. 2004/0114457 to McGill shows a food blending apparatus for blending products that provides the materials in the container and allows for the materials to be blended in the container with the container be disposed of after the material has been dispensed from the container as in U.S. Pat. No. 6,338,569 requires a complex sealing means to ensure that the food within the container does not leak out between the lid and the blender that extends through the lid and therefore increases the cost of the container.

U.S. Pat. No. 6,071,006 to Hochstein shows a container for vending machines with a stirring shaft extending into the container from a cover. The stirring shaft is rotated by a rotating device to mix the contents of the container with the cover being removed or pierced to gain access to the contents of the container the process by which the container and stirring shaft are constructed increase the cost to produce the container. U.S. Pat. No. 1,519,798 to Pilkington shows a drink mixer that incorporates a stirrer in a glass to allow the contents of the glass to be mixed when the stirrer is rotated. The use of a glass container makes it cost prohibitive to dispose of the container after each use and therefore requires the user to clean the container after each use. U.S. Pat. No. 5,855,431 to Costanzo shows a rotating mixer and tray with a container with a whisk that extends through the base of the container and is coupled to a gear under the base of the container which rotates the whisk to stir the contents of the liquid when the gear is rotated by the motor in the motor housing unit, additionally, the container is intended to be reused and therefore requires the user to clean the container after every use.

U.S. Pat. No. 6,709,150 to Lin shows a juice blender having a container with a horizontal partition formed with a skirt and blades on a rotor positioned in the container for mixing the materials in the container. A coupler is positioned in the skirt of the container and engages a motor to turn the rotor and blades to mix the contents of the container. Additionally, the container is not intended to be discarded after every use and therefore requires the user to clean the container after every use. U.S. Pat. No. 5,639,161 to Sirianni shows a pressured switch-controlled blender cup apparatus with a hollow base that houses a motor, power supply and a variety of switches and a propeller coupled to the rotor of the motor extending through the bottom wall and into the cup and mixing materials in the cup when the cup is placed in the surface. The cup is not intended to be disposed of after each use and therefore requires cleaning of the cup and the propeller after each use.

In these respects, the drink blender system with a single use disposable drink container according to the present invention substantially departs from the conventional concepts and designs of the prior art, and in so doing provides an apparatus primarily developed for the purpose of permitting a user to dispose of the cup and mixing apparatus after use.

### SUMMARY OF THE INVENTION

In view of the foregoing disadvantages inherent in the known types of food blenders now present in the prior art, the present invention provides a new drink blender system with a single use disposable drink container construction wherein the same can be utilized for permitting a user to dispose of the cup and mixing apparatus after use.

To attain this, the present invention generally comprises a cup defining an interior for receiving constituents of the drink. The cup has an upper end and a lower end. The upper end of the cup having an opening into the interior. A mixing apparatus integrally formed as a single unit with the cup. The mixing apparatus is mounted on the lower end of the cup. The mixing apparatus extends upwardly from the lower end into the interior of the cup. A driver assembly drives the mixing apparatus to mix the constituents of the drink.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the integration of the mixing apparatus with the cup to allow the drink to be mixed in a single unit and once the drink is removed from the interior of the cup, the cup and the mixing apparatus are disposed of.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a perspective view of a new drink blender system with a single use disposable drink container according to the present invention.

FIG. 2 is a cross-sectional view of the present invention taken along line 2-2 of FIG. 1.

### DESCRIPTION OF PREFERRED EMBODIMENTS

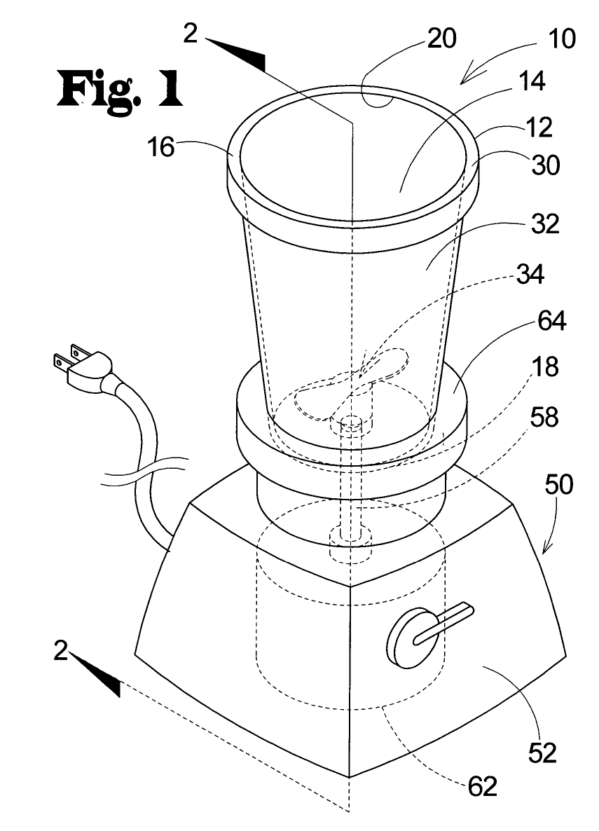

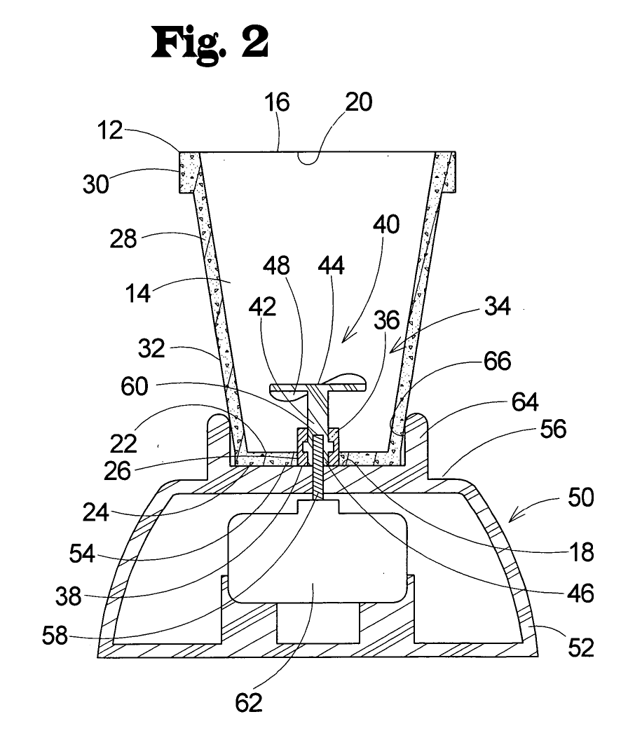

With reference now to the drawings, and in particular to FIGS. 1 and 2 thereof, a new drink blender system with a single use disposable drink container embodying the principles and concepts of the present invention and generally designated by the reference numeral 10 will be described.

As best illustrated in FIGS. 1 and 2, the drink blender system with a single use disposable drink container 10 generally comprises a cup 12 defining an interior 14 for receiving constituents of the drink. The cup 12 has an upper end 16 and a lower end 18. The upper end 16 of the cup 12 has an opening 20 into the interior 14.

The cup 12 comprises a bottom wall 22 at the lower end 18 of the cup 12. The bottom wall 22 has a lower surface 24 for resting on a support. The bottom wall 22 has an aperture 26 therethrough into the interior 14 of the cup 12. The aperture 26 may be substantially centered on the bottom wall 22. The cup 12 further comprises a perimeter wall 28 that is irremovably mounted on the bottom wall 22 to form the interior 14 of the cup 12. The perimeter wall 28 may have a generally inverted frustaconical shape such that a diameter of the upper end 16 of the cup 12 is greater than a diameter of the lower end 18 of the cup 12. The perimeter wall 28 has an upper rim portion 30 about the opening 20 at the upper end 16 of the cup 12. Significantly, the perimeter wall 28 has a lower portion 32 that terminates at the bottom wall 22 so that no portion of the perimeter wall 28 extends beyond and below the bottom wall 22. This relationship provides an almost entirely flat bottom surface for the cup 12, which facilitates resting the cup 12 on a surface in a stable manner with the drink inside. Preferably, the bottom surface is substantially planar.

Preferably, the bottom wall 22 and the perimeter wall 28 are formed of a plastic. The plastic of the bottom and perimeter walls 22,28 may be tearable into pieces by a human hand so as to be compactly disposed of after use. The plastic may be opaque and may comprise an expanded rigid polystyrene.

A mixing apparatus 34 is integrally formed as a single unit with the cup 12. The mixing apparatus 34 is mounted on the bottom wall 22 of the cup 12. The mixing apparatus 34 extends upwardly from the bottom wall 22 into the interior 14 of the cup 12.

The mixing apparatus 34 comprises a pedestal 36 that is irremovably mounted on the bottom wall 22 of the cup 12 and extends into the interior 14 of the cup 12. The pedestal 36 has a bottom end 38 positioned in the aperture 26 of the bottom wall 22 and is irremovably mounted on the portion of the bottom wall 22 that defines the aperture 26. The bottom end 38 of the pedestal 36 is substantially flush with the lower surface 24 of the bottom wall 22 so that the cup 12 may be rested in a stable condition on the surface. The pedestal 36 also has an interior 14.

The mixing apparatus 34 further comprises an impeller assembly 40 that is rotatably mounted on the pedestal 36. The impeller assembly 40 rotates about an axis that extends vertically from the lower end 18 of the cup 12 to the upper end 16 of the cup 12.

The impeller assembly 40 includes a rotatable shaft 42 that extends into the pedestal 36. The rotatable shaft 42 has an upper end 44 and a lower end 46. The lower end 46 of the rotatable shaft 42 has a cavity 47 for receiving a driver shaft 58 that will be described in greater detail below. At least one blade 48 is mounted on the rotatable shaft 42 and extends laterally outwardly from the axis of rotation of the impeller assembly 40. The blade 48 of the impeller assembly 40 is mounted on the upper end 44 of the impeller assembly 40. Preferably, the impeller assembly 40 includes two blades 48.

In a highly preferable embodiment, the pedestal 36, the rotatable shaft 42, and the blades 48 are formed of a substantially rigid plastic that is suitable for normal disposal, or, optionally recycling. The plastic materials for the elements of the invention not only reduce the cost of the cup 12, but also reduce the weight of the cup 12 relative to the liquid held in the interior 14. Further, plastics can require little lubrication, or be self lubricating, so as to be able to function over the short mixing period associated with a single use container. Due to the limited usage of these components, there may be no need for any lubrication or friction reducing bearings or bushings that would increase the complexity and cost of the cup.

A driver assembly 50 drives the impeller assembly 40 of the mixing apparatus 34. The driver assembly 50 includes a base 52 having a resting surface 54 on an upper location 56 on the base 52. The driver assembly 50 further includes a driver shaft 58 extending upwardly from the upper location 56 of the base 52. The driver shaft 58 is rotatable. The driver shaft 58 has a free upper end 60 that is configured to be inserted into the cavity in the lower end 46 of the rotatable shaft 42 when the cup 12 is rested on the resting surface 54 of the base 52 so that rotation of the shaft 42 is transferred to the impeller assembly 40. The shaft 42 may also includes splines or a polyhedral cross section to engage a cooperative structure in the cavity 47. The driver assembly 50 further comprises a motor 62 mounted on the base 52 for rotating the driver shaft 58.

The driver assembly 50 further comprises a guide wall 64 extending upwardly from the base 52 about the resting surface 54 to create a holding space for receiving the lower end 18 of the cup 12 and holding the cup 12 in position while the driver shaft 58 is inserted into the cavity in the lower end 46 of the rotatable shaft 42. The guide wall 64 may be substantially annular. Preferably, the guide wall 64 has an inner surface 66 that is configured to fit snugly against an outer surface of the perimeter wall 28 of the cup 12 and can serve to partially reinforce the lower portion of the cup during mixing.

In use, the user places the bottom wall 22 of the cup 12 onto the resting surface 54 of the driver assembly 50 with the guide wall 64 positioned around a portion of the perimeter wall 28 of the cup 12 to inhibit the cup 12 from inadvertently tipping over. The placement of the cup 12 on the resting surface 54 inserts the driver shaft 58 into the cavity 47 in the lower end 46 of the rotatable shaft 42 of the impeller assembly 40. The motor 62 of the driver assembly 50 is actuated to rotate the driver shaft 58 which rotates the rotatable shaft 42 and the blades 48 to mix the constituents in the interior 14 of the cup 12. When the user has finished drinking or pouring the drink from the interior 14 of the cup 12, the user does not wash the cup for reuse, but instead the user can discard the cup 12 and mixing apparatus 34, thereby removing the requirement to clean the cup 12 after each use. Another cup may be obtained for a subsequent drink, and may be mixed using the same driver assemnbly.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for blending a drink using a single use, disposable cup, the system comprising:
a single use, disposable cup defining an interior for receiving constituents of the drink, the cup having an upper end and a lower end, the upper end of the cup having an opening into the interior;
a mixing apparatus integrally formed as a single unit with the cup, the mixing apparatus being mounted on the lower end of the cup, the mixing apparatus extending upwardly from the lower end into the interior of the cup; and
a driver assembly for driving the mixing apparatus to mix the constituents of the drink, the cup and mixing apparatus being removably mountable on the driver assembly.

2. The system as set forth in claim 1, wherein the cup comprises a bottom wall at the lower end of the cup, the bottom wall having a substantially flat lower surface for resting on a support.

3. The system as set forth in claim 2, wherein the cup comprises a perimeter wall irremovably mounted on the bottom wall to form the interior of the cup.

4. The system as set forth in claim 3, wherein the perimeter wall has a generally inverted frustaconical shape such that a diameter of the upper end of the cup is greater than a diameter of the lower end of the cup.

5. The system as set forth in claim 3, wherein the perimeter wall has an upper rim portion about the opening at the upper end of the cup.

6. The system as set forth in claim 3, wherein the perimeter wall has a lower portion terminating at the bottom wall such that no portion of the perimeter wall extends beyond and below the bottom wall.

7. The system as set forth in claim 3, wherein the bottom wall and the perimeter wall are formed of a plastic, the plastic of the bottom and perimeter walls being tearable into pieces by a human hand.

8. The system as set forth in claim 1, wherein the mixing apparatus comprises a pedestal irremovably mounted on the cup and extending into the interior of the cup, the pedestal having a bottom end positioned in an aperture of a bottom wall of the cup in a manner such that the bottom end of the pedestal is substantially flush with a plane of the lower surface of the bottom wall.

9. The system as set forth in claim 8, wherein the mixing apparatus comprises an impeller assembly rotatably mounted on the pedestal, the impeller assembly rotating about an axis extending from the lower end of the cup to the upper end of the cup.

10. The system as set forth in claim 9, wherein the impeller assembly comprises a rotatable shaft extending in the pedestal, the rotatable shaft having an upper end and a lower end, the lower end engaging the driver assembly.

11. The system as set forth in claim 10, wherein the impeller assembly comprises at least one blade mounted on the rotatable shaft and extending laterally outwardly from the axis of rotation of the impeller assembly, the impeller assembly blade being mounted on the upper end of the impeller assembly.

12. The system as set forth in claim 10, wherein the pedestal, the rotatable shaft, and the at least one blade is formed of a substantially rigid plastic

13. The system as set forth in claim 1, wherein the driver assembly comprises a base having a resting surface on an upper location on the base.

14. The system as set forth in claim 13, wherein the driver assembly comprises a driver shaft extending upwardly from the upper location of the base, the driver shaft being rotatable, the driver shaft having a free upper end configured to engage the mixing apparatus when the cup is rested on the resting surface of the base.

15. The system as set forth in claim 14, wherein the driver assembly comprises a motor mounted on the base for rotating the driver shaft.

16. The system as set forth in claim 14, wherein the driver assembly comprises a guide wall extending upwardly from the base about the resting surface to create a holding space for receiving the lower end of the cup and holding the cup in position while the driver shaft engages the mixing apparatus.

17. The system as set forth in claim 16, wherein the guide wall has an inner surface configured to fit snugly against an outer surface of the perimeter wall of the cup to support the cup during mixing.

18. A system for blending a drink, comprising:
a cup defining an interior for receiving constituents of the drink, the cup having an upper end and a lower end, the upper end of the cup having an opening into the interior, the cup comprising:
a bottom wall at the lower end of the cup, the bottom wall having a lower surface for resting on a support, the bottom wall having an aperture therethrough into the interior of the cup, the aperture being substantially centered on the bottom wall; and
a perimeter wall irremovably mounted on the bottom wall to form the interior of the cup, the perimeter wall having a generally inverted frustaconical shape such that a diameter of the upper end of the cup is greater than a diameter of the lower end of the cup, the perimeter wall having an upper rim portion about the opening at the upper end of the cup;
wherein the perimeter wall has a lower portion terminating at the bottom wall such that no portion of the perimeter wall extends beyond and below the bottom wall;
wherein the bottom wall and the perimeter wall are formed of a plastic, the plastic of the bottom and perimeter walls being tearable into pieces by a human hand, the plastic being opaque, the plastic comprising an expanded rigid polystyrene;
a mixing apparatus integrally formed as a single unit with the cup, the mixing apparatus being mounted on the bottom wall of the cup, the mixing apparatus extending upwardly from the bottom wall into the interior of the cup, the mixing apparatus comprising:
a pedestal irremovably mounted on the bottom wall of the cup and extending into the interior of the cup, the pedestal having a bottom end positioned in the aperture of the bottom wall and being irremovably mounted on the bottom wall about the aperture such that the bottom end of the pedestal is substantially flush with the lower surface of the bottom wall, the pedestal having an interior;
an impeller assembly rotatably mounted on the pedestal, the impeller assembly rotating about an axis extending from the lower end of the cup to the upper end of the cup, the impeller assembly comprising:
a rotatable shaft extending in the pedestal, the rotatable shaft having an upper end and a lower end, the lower end of the rotatable shaft having a cavity for receiving a driver shaft;
at least one blade mounted on the rotatable shaft and extending laterally outwardly from the axis of rotation of the impeller assembly, the impeller assembly blade being mounted on the upper end of the impeller assembly, the at least one blade including two blades;
wherein the rotatable shaft and the at least one blade is formed of a substantially rigid plastic;
a driver assembly for driving the impeller assembly of the mixing apparatus, the driver assembly comprising:
a base having a resting surface on an upper location on the base;
a driver shaft extending upwardly from the upper location of the base, the driver shaft being rotatable, the driver shaft having a free upper end configured to be inserted into the cavity in the lower end of the rotatable shaft when the cup is rested on the resting surface of the base;
a motor mounted on the base for rotating the driver shaft;
a guide wall extending upwardly from the base about the resting surface to create a holding space for receiving the lower end of the cup and holding the cup in position while the driver shaft is inserted into the cavity in the lower end of the rotatable shaft, the guide wall being substantially annular, the guide wall having an inner surface configured to fit snugly against an outer surface of the perimeter wall of the cup.
